(19) United States
(12) Patent Application Publication
(10) Pub. No.: US 2013/0004619 A1
(43) Pub. Date: Jan. 3, 2013

(54) Method of Forming Encapsulated Compositions with Enhanced Solubility and Stability

(75) Inventors: Pei-Yong Chow, Singapore (SG); Lay-Beng Goh, Singapore (SG)

(73) Assignee: KEMIN INDUSTRIES, INC., Des Moines, IA (US)

(21) Appl. No.: 13/534,779

(22) Filed: Jun. 27, 2012

Related U.S. Application Data
(60) Provisional application No. 61/502,156, filed on Jun. 28, 2011.

(51) Int. Cl. A23D 7/005; A23L 1/302; A23L 1/304; B05D 7/00

(52) U.S. Cl. 426/72; 427/212; 426/602; 426/74

(57) ABSTRACT

A method of forming an encapsulated composition with enhanced solubility and stability. A bicontinuous or Winsor Type III microemulsion is formed using an emulsifier, a solvent and a co-emulsifier. An active composition is added to the microemulsion resulting in a micellar network of the active composition within the microemulsion. The active composition can be either water-soluble or oil-soluble or both.

This application claims priority to U.S. Patent Application Ser. No. 61/502,156, filed Jun. 30, 2011, which is incorporated herein in its entirety by this reference.

### BACKGROUND OF THE INVENTION

The present invention relates generally to food grade microemulsions and, more specifically, to a novel method of creating food grade particles of reduced size with enhanced solubility and stability.

Administering of active nutraceuticals or food supplements into animals is best achieved by the use of an appropriate vehicle that can bring an effective amount of the actives to the desired site in the animals, in an intact form. Most of these actives either dissolve very poorly in oil or water, posing a problem en route between administration and target absorption. However, many chemicals that can serve as appropriate delivery vehicles for such actives have not been approved for use with animals, due to safety or toxicity concerns. Thus, constructing the appropriate and effective delivery vehicle for these actives poses a challenge to most researchers.

Carotenoids are a group of colored pigments which have a yellow to red hue and are widely found in nature, and impart a characteristic color to feedstuffs. Some important examples of this category include lutein, capsanthin, zeaxanthin and carotene. They constitute an important class of natural pigments that are in demand for the food and animal feed industry as substitutes for artificial colorants. Furthermore, these are not synthesized in the body and therefore, dietary ingestion is the only source for the supplementation. All carotenoids are water-insoluble, and slightly soluble in fat and oils. This limited solubility hinders direct use of the relatively coarse carotenoids, obtained from synthesis for pigmentation, since only low color yields can be achieved. In addition, the coarse carotenoid is poorly absorbed during gastrointestinal passage due to non-uniform particle size.

A common approach in attempting the construction of such a vehicle is through the use of microemulsions. Microemulsions are thermodynamically stable, transparent, low viscosity and isotropic dispersions consisting of oil and water, stabilized by an interfacial film of surfactant molecules, typically in conjunction with a co-surfactant. Investigations in microemulsions¹⁻⁷ generally focus at forming either water-in-oil (W/O) or oil-in-water (O/W) microemulsions, as micro-reactors where the concentrates (surfactant and oil phases) are loaded with actives. However, they typically consist of ‘reverse micelles’ or ‘surfactant-in-oil phases’ that cannot be inverted into oil-in-water droplets upon simple aqueous dilution. Such a product will not be suitable as an additive, where it would be diluted and destabilized in an aqueous environment. Aqueous dilution is also encountered as they enter the biological system, moving through the various stages of absorption and distribution within the animal body. Hence, such microemulsion products would have little practical value.

In recent studies⁸⁻¹¹, scientists have found unique mixtures of food-grade oils, which can be diluted with an aqueous phase progressively and continuously without phase separation, and are transformed into bicontinuous structures that, upon further dilution, can be inverted into oil-in-water nanodroplets. These unique mixtures consist of two or more food-grade nonionic hydrophilic emulsifiers that self-assemble to form mixed reverse micelles (the concentrate).

The bicontinuous microemulsions¹² (Winsor Type III) has been an active research topic because their unique structure lends itself well to controlled release application. Amphiphilic molecules form bicontinuous water and oil channels, where “bicontinuous” refers to two distinct (continuous, but non-intersecting) hydrophilic regions separated by bilayers. This allows for simultaneous incorporation of water- and oil-soluble active ingredients and the phase structure provides a tortuous diffusion pathway for controlled release of the encapsulated ingredients. Despite recent activities, there remains a gap in the translation of the technique into a feasible and practical application. Difficulties include achieving a reasonable level of product stability to provide a reasonable shelf life, manufacturing scalability, and customization using regulatory-approved material, hindering the progress in the development of food-grade bicontinuous microemulsions into commercial products.

This present invention is the novel development of a stable product, made through the optimization of food grade bicontinuous microemulsion production for the encapsulation of carotenoids from marigold extracts. The physicochemical properties of the bicontinuous microemulsions are characterized and the heat stability and bioavailability are evaluated.

### SUMMARY OF THE INVENTION

There is growing interest within the food and feed industries in the utilization of colloidal delivery systems to encapsulate functional ingredients. Microemulsions are of particular interest as colloidal delivery systems because they can be easily fabricated from food-grade ingredients, using relatively simple processing operations.

The present invention provides a novel method and composition for encapsulating a wide variety of water-soluble/oil-soluble agents into the bicontinous microemulsion nanostructures (e.g., nanoparticles or particles having a size of less than about 500 nanometers). The method involves forming a carotenoid-based pigmenter containing a bicontinuous microemulsion consisting of unique mixtures of food-grade oils, two or more food-grade nonionic hydrophilic emulsifiers, a co-solvent, co-emulsifiers, and an active composition or agent. In the preferred embodiment, the emulsifier is polysorbate 80, the co-solvent is either glycerol or limonene, the co-emulsifier is ethanol, and the active composition is free-form carotenoids obtained through a saponification reaction.

In particular, the present invention includes the novel use of water-dilutable Winsor Type III (bicontinuous) food-grade microemulsions, consisting of ethoxylated sorbitan ester (TWEEN® 80), water, R-(+)-limonene, ethanol and glycerol, as nano-vehicles for enhancing the solubilization and stability against rapid environmental reactivity of food grade compositions, particularly carotenoids. Maximum solubilization was obtained within the bicontinuous microemulsion phase. This was at 6-8 times more than the dissolution capacity of the oil (limonene) for the same compounds with varying aqueous content. The solubilization capacity of carotenoids along a dilution line in a pseudo-ternary phase diagram was correlated to the microstructure transitions along the dilution line. On this dilution line, the weight ratio of limonene/ethanol/polysorbate 80 was held constant at 1:2:3. The stability of carotenoids in microemulsions was investigated. There was a 13% and 24% drop in the total carotenoids content when exposed to 25° C. and 65° C., respectively, for 1 month. This is considered to be rather stable for a microemulsion. In addition, the particle size distribution of the prototype was relatively uniform, with a mean diameter of about 500 nm.

The microemulsions according to this invention include wherein the aqueous or oil phase may contain dissolved materials selected from colorants, vitamins, antioxidants, extracts of natural components (such as plant roots, leaves, seeds, flowers, etc.), medicaments, eye dyes, simple phenols, polyphenols, bioflavonoids, dairy products, proteins, peptides, amino acids, salts, sugars, sweeteners, flavors, flavor precursors, nutrients, minerals, acids and seasonings, and mixtures thereof in the same microemulsion.

The present invention provides a novel method and composition for encapsulating a wide variety of water-soluble/oil-soluble agents into the bicontinuous microemulsion nanostructures (e.g., nanoparticles or particles having a size of less than 1 micron).

The bicontinuous microemulsion is used to enhance encapsulation and stability of amphiphilic or lipophilic oil-soluble or hydrophilic water-soluble materials into feed and food compositions, comprising: (a) an oil phase comprising said amphiphilic or lipophilic oil-soluble material; (b) an aqueous phase comprising said amphiphilic or hydrophilic water-soluble material; and (c) a food grade emulsifier system containing (i) an ionic or iron-ionic or zwitterionic emulsifier and (ii) a co-emulsifier, wherein said oil phase is dispersed as particles having an average diameter of below 1 μm, within said aqueous phase or wherein said aqueous phase is dispersed as particles or continuous phase having an average diameter of below 1 μm, within said oil phase.

The bicontinuous microemulsion according to this invention comprises aqueous phase at from about 10% to about 90% of the total, the balance being oil phase and food grade emulsifier system, of which the oil phase comprises from about 10% to about 90% of the total, the balance being aqueous phase and food grade emulsifier system.

The bicontinuous microemulsion according to this invention comprises an aqueous or oil phase which contains dissolved materials selected from colorants, vitamins, juices, antioxidants, extracts of natural components (such as plant roots, leaves, seeds, flowers, etc.), medicaments, simple phenols, polyphenols, bioflavonoids, dairy products, proteins (including enzymes), peptides, amino acids, salts, sugars, sweeteners, flavors, flavor precursors, nutrients, minerals, acids and seasonings, or mixtures thereof.

The bicontinuous microemulsion according to this invention comprises an emulsifier that is selected from glycerol ester of fatty acids, monoglycerides, diglycerides, ethoxylated monoglycerides, polyglycerol ester of fatty acids, lecithin, glycerol ester of fatty acids, sorbitan esters of fatty acids, sucrose esters of fatty acids, or mixtures thereof.

The bicontinuous microemulsion according to this invention comprises a co-emulsifier that is a water miscible alcohol emulsifying agent selected from the group consisting of ethanol, propanol, propylene glycol, glycerol or mixtures thereof.

The bicontinuous microemulsion according to this invention comprises an oil selected from the group consisting of limonene, vegetable oils, animal oils, polyol polyesters and mixtures thereof.

### BRIEF DESCRIPTION OF THE DRAWINGS

FIG. 1 is a chart of the phase behavior of the transparent microemulsion region of the system composing of polysorbate 80/ethanol/limonene/glycerol/H₂O; the weight ratio of limonene to ethanol and glycerol to water were fixed at 1:2 and 1:3 while that for oil to surfactant was at 1:1 along line P with increasing water content.

FIG. 2 is a chart of the changes in conductivity of microemulsions along P-line with increasing aqueous content.

FIG. 3 is a chart of the maximum solubilization of carotenoids in microemulsions consisting of polysorbate 80/ethanol/limonene/glycerol/water; parameters were plotted against the aqueous content along dilution along line P.

FIG. 4 is a chart of the UV-Vis absorption of the carotenoids-encapsulated microemulsion after storage at 25° C. for 1 month.

FIG. 5 is a chart of the UV-Vis absorption of the carotenoids-encapsulated microemulsion after storage at 25° C. and 65° C. for 1 month.

FIG. 6A is a TEM micrograph of microemulsion (without carotenoids); FIG. 6B is a TEM micrograph of carotenoid-microemulsions; and FIG. 6B is a TEM micrograph of saponified carotenoids concentrate.

FIG. 7 is a chart of the particle size distribution of the carotenoid-microemulsion sample.

FIGS. 8(a) and (b) are charts of the particle size analysis of (a) Kem GLO 10 liquid precursor and (b) nanodispersed Kem GLO 10 liquid precursor.

FIG. 9 is a chart of the particle size distribution of the nanodispersed Kem GLO 10 liquid precursor at the 0th, 7th, 14th, 21st and 28th day at room temperature (25° C.).

FIG. 10 is a chart of the effect of pigment treatment on the trans-capsanthin absorption in blood plasma.

FIG. 11 is a chart of the effect of pigment treatment on the trans-capsanthin deposition in egg yolk.

FIG. 12 is a chart of the effect of pigment treatment on the YCF score of eggs.

### DETAILED DESCRIPTION OF PREFERRED EMBODIMENTS

Suitable bicontinuous microemulsions can be formed when proportions of the components are respectively from about 15 to about 50% for the aqueous phase (such as glycerol/water, propylene glycol/water or water), from about 5% to about 40% for the oil phase (such as limonene, ethanol, limonene/ethanol, mineral oil, soya bean oil) and from about 10% to about 50% for the surfactants (Polysorbate 60, Polysorbate 65, Polysorbate 80, lecithin and lecithin derivatives, mono- and diglycerides, sorbitan fatty acid esters) all percentages by weight (denoted wt % hereafter). Persons skilled in the art will understand how to combine different oil and surfactants in different ratios to achieve the desired effect on the various properties of the resulting formulation, for example, to improve the active ingredients solubilization capacity or stability of the resulting formulation.

### Example 1

### Materials and Methods

Materials.

Polysorbate 80 (polyoxyethylene (20) sorbitan monooleate; TWEEN® 80), R-(+)-limonene, ethanol and glycerol were of food grade. All chemicals and reagents used in the analytical protocols were of analytical reagent grade. The water was double-distilled. The control carotenoid source used was a stabilized source of saponified yellow carotenoids from marigold extracts (OroGLO® 24 Dry, Kemin Industries, Inc.).

Phase Diagram and Electrical Conductivity.

The single-phase region of the microemulsion⁶ consisting of polysorbate 80/ethanol/limonene/glycerol/H₂O was determined systematically by titrating water to various compositions of polysorbate 80, ethanol, limonene and glycerol, in a screw-capped test tube. Each sample was vortex-mixed and allowed to equilibrate in a temperature-controlled environment at 25° C. A stock solution of water and glycerol at a constant weight ratio of 3:1 was made. The ethanol/limonene weight ratio was held constant at 1:2. Mixtures of surfactant/oil phase (ethanol and limonene) or mixtures of surfactant/aqueous phase (water and glycerol) were prepared in culture tubes, sealed with screw caps at predetermined weight ratios of oil phase to surfactant, or aqueous phase to surfactant, and kept in a 25° C. (±0.3° C.) water bath. Microemulsion areas were determined in phase diagrams by titrating either the oil/surfactant phase or aqueous phase/surfactant mixtures with the aqueous phase or the oil phase, respectively. All samples were vigorously stirred. The samples were allowed to equilibrate for at least 24 h before they were examined.

The microemulsion region was further classified as either oil-in-water (O/W), bicontinuous or water-in-oil (W/O) microemulsions. A rough demarcation of the bicontinuous region was further deduced from conductivity measurements.⁶ Electrical conductivity measurements were performed at 25±0.2° C. on samples along the dilution line P using a conductivity meter (Extech EC500, pH/conductivity meter). Since the microemulsions were nonionic, a small quantity of an aqueous electrolyte (a solution of 0.01 M NaCl) was added. The samples remained clear and there were no observable changes in the phase diagram.

Carotenoid-Microemulsion Preparation.

The sample was prepared as follows. Based on the formulation for the OroGLO® 24 Dry product, 38.0 g of saponified OroGLO® concentrate was added to the mixing vessel followed by 15.0 g of the pre-prepared microemulsion. The microemulsion consisted of 32.5% polysorbate 80, 32.5% limonene/ethanol (1:2), 35.0% glycerol/water (1:3). All contents were mixed until a homogeneous mixture of carotenoid-microemulsion was observed. The sample was then added with 47 g of one or more inert carriers and blended to achieve a free-flowing powder.

Centrifugal Stress Test.

The microemulsion stability of the formulation was tested by subjecting them to a centrifugal stress test. About 15 g of sample was placed in a transparent polymer tube and subjected to 24,000 g centrifugal force for 15 minutes (B. Braun Biotech Centrifuge ER 15P). The centrifuged samples were observed under fluorescent light for the degree of phase separation. The viscosity of the formulations was tested using a Brookfield viscometer model DV-I+.

Viscosity and Refractive Index Measurement.

The refractive index of the formulations was determined using an Abbe-type digital refractometer (Reichert-Jung, Abbe Mark II) by placing one drop of the formulation on the slide in triplicate at 25° C.

Solubilization Measurement.

Saponified carotenoids and limonene were first mixed. Water, glycerol, ethanol and Polysorbate 80 were then added dropwise to obtain a single-phase clear microemulsion with the desired composition. Finally, the samples were cooled and stored at 25° C. Samples that remained transparent for at least 5 days were considered to be microemulsions.

Stability Study and Spectrophotometric Determination of Total Carotenoid (SOP-10-00072).

The stability of microemulsions over time was monitored by UV/Vis absorption measurement. For unstable microemulsions, the encapsulated carotenoids would be released instantly and the UV/Vis absorption of the sample would decrease. The sample was first prepared by adding 0.5 g (+/−0.1 mg) of the carotenoid-microemulsion to a 100-ml brown volumetric flask. The flask was filled with a mixture of hexane:ethanol:acetone:toluene at a ratio of 10:6:7:7 (HEAT) as the extracting solvent, and stirred with a magnetic stir bar for 15 min. Five ml was transferred by pipette to a 50 ml brown volumetric flask, diluted to the mark with HEAT, and shaken to mix the contents. A cuvette was filled with the solution and absorbance was measured at 460 nm against the extracting solvent using a spectrophotometer (UV-2401PC, Shimadzu).

Morphology of Carotenoid-Microemulsion.

To observe the morphologies, carotenoid-microemulsions and yellow carotenoids were directly deposited onto carbon film supported by copper grids, stained with 1% aqueous solution of osmium tetroxide (OsO₄) and investigated using the transmission electron microscope (TEM) JEOL 1010

Particle Size Analysis.

The carotenoid-microemulsion sample was put through size analysis using a particle size analyzer (Horiba Particle size analyzer LA-950).

### Results

Phase Diagrams and Conductivity Measurement.

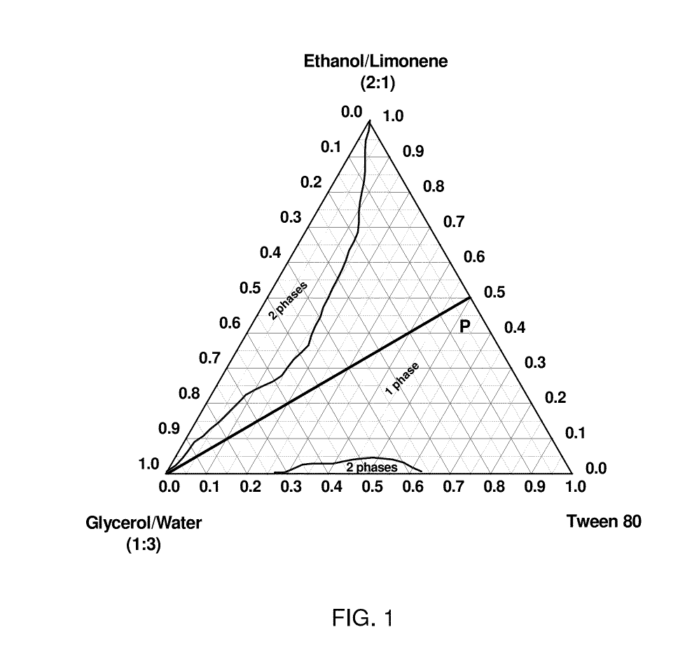

FIG. 1 shows the phase behavior of the transparent microemulsion region (dotted area) of the system composing of polysorbate 80/ethanol/limonene/glycerol/H₂O. The shaded region represents the wide range of compositions that can be selected to form transparent microemulsions. Based on the diagram, microemulsions can be formed using an aqueous content ranging from about 20 to 100 wt %.

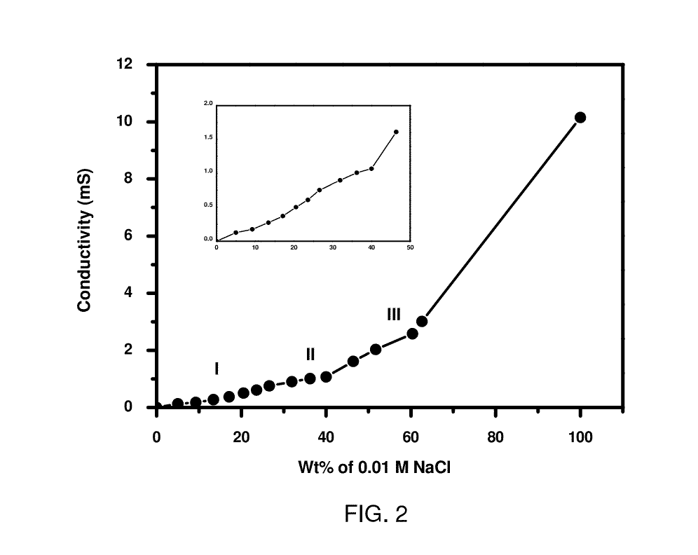

The changes of conductivity of microemulsions along P-line with the aqueous content are shown in FIG. 2. It shows the low conductivity of microemulsion at lower aqueous water content (<20 wt %), followed by a rapid increase in conductivity when the aqueous content was greater than 20 wt %.

Based on the conductivity measurements, the system containing 35 wt % water was found to be a bicontinuous microemulsion. This was then chosen for a detailed study.

The bicontinuous carotenoid-microemulsion system was stable and able to maintain homogeneity in an emulsion-break (centrifuge) test. The viscosity was less than 100 cP (˜72.4-77.5 cP) and the refractive index of microemulsions was 1.4106.

Solubilization Capacity.

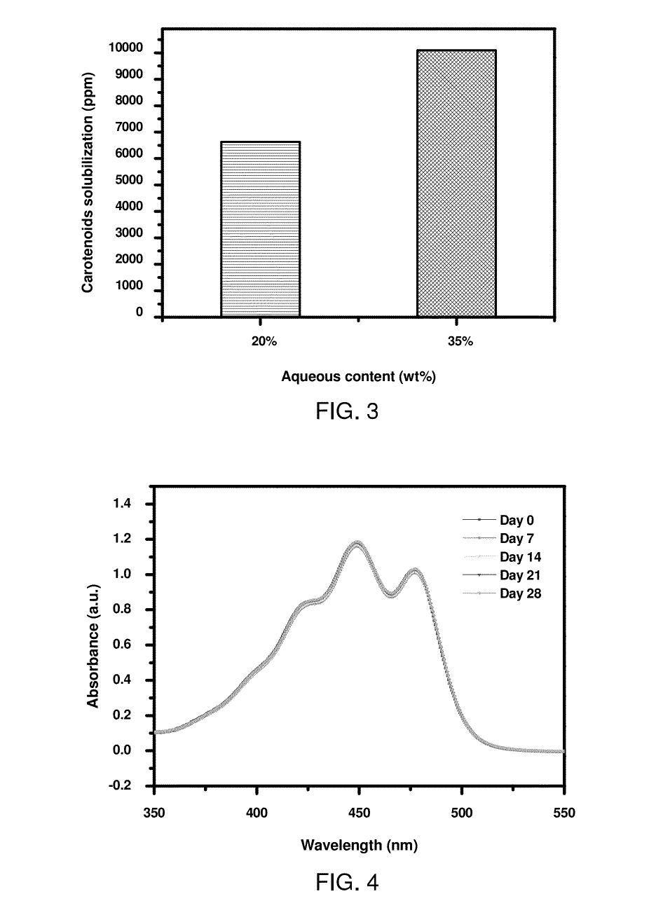

FIG. 3 shows the solubility of carotenoids in the microemulsion components at 20 wt % and 35 wt % water. The solubilization of carotenoids in microemulsions systems with 20 wt % water and 35 wt % water was ˜6 times (6630 ppm) and ˜8.4 times (10,100 ppm), respectively, higher than the solubility of carotenoids in (R)-(+)-limonene (1200 ppm).

Stability Study.

FIG. 4 shows the UV-Vis absorption of the carotenoids-encapsulated microemulsion after 1 month at room temperature (25° C.). There were no significant differences in the absorption curve of UV-Vis spectra among the microemulsions during 1-month study. No carotenoids were released from the microemulsion, and there were no signs of aggregation after 1 month.

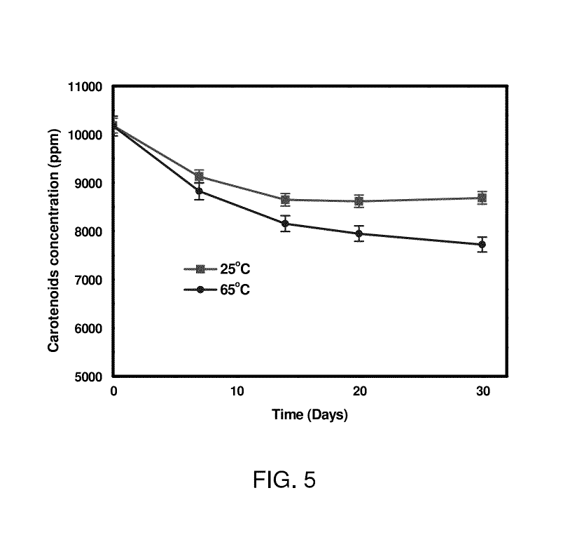

FIG. 5 shows the changes in the concentration of carotenoids in the microemulsions over time. There was a slow degradation, resulting in 13% and 24% drop in the total carotenoids content when exposed to 25° C. and 65° C., respectively, for 1 month.

Morphology of the Carotenoid-Microemulsions.

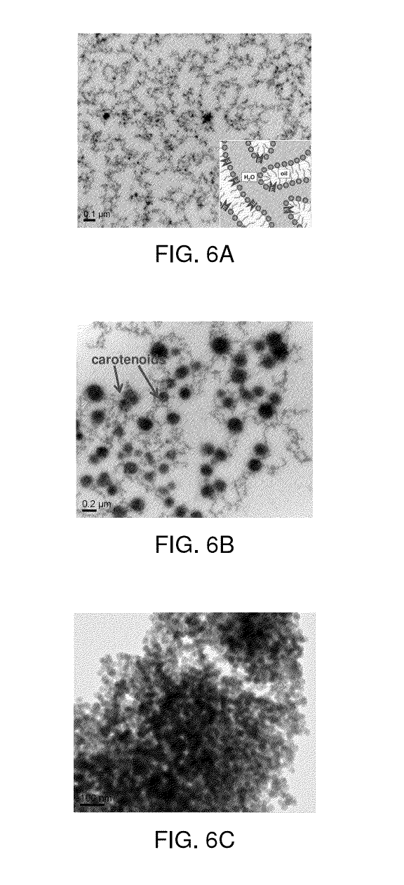

FIGS. 6A and B show the TEM images of the bicontinuous microemulsion of 35 wt % aqueous content without and with carotenoids respectively. As shown in FIG. 6A, a micellar network formed by branched micelles was found. It was an interconnected, branched micellar network, spanning over a large space, analogous to the bicontinuous phase, where an infinite multi-connected fluid bilayer usually separates the hydrophilic region from the hydrophobic region. As seen in FIG. 6B, the particles were slightly larger than 100 nm in diameter.

Most of the particles appear spherical in shape in the well-dispersed microemulsion system. This contrasted with FIG. 6C which shows the agglomerated TEM image of the saponified carotenoid concentrate. The agglomeration was expected because there was no surfactant attached to the surface of the carotenoids to maintain them in a dispersed state.

Particle Size Analysis.

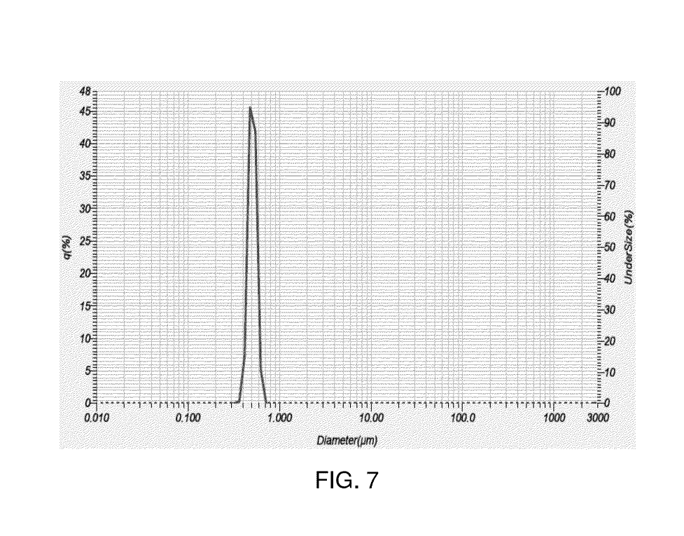

The particle size distribution of the carotenoid-microemulsion sample was as shown in the FIG. 7. The mean diameter of the carotenoid-microemulsion was relatively uniform with a particle size of ˜500 nm.

### Discussion

Food-grade bicontinuous microemulsions offer unique properties of particular interest to the food and feed industry. The materials can be formed by simple combination of unique mixtures of food-grade oils and surfactants with water. In our study, carotenoids were found to be solubilized in the bicontinuous microemulsions up to 6-8 times more than their solubility in R-(+)-limonene per se. The microemulsion system has demonstrated that it can be diluted by water, an important property that will enable it to be applied across food and feed industries. In addition, this system can be diluted with an oil phase (including (R)-(+)-limonene) and, therefore, is also suitable for oil-continuous phase applications. It is essential, therefore, to construct microemulsion concentrates that are capable of dilution in both oil and water phases. The microemulsions described in this paper are unique in these properties.

As seen in FIG. 6B, the particles were slightly larger than 100 nm in diameter. This is in line with the results of particle sizing in FIG. 7, showing a uniform mean diameter of around 500 nm. In addition, it is noted at this point that the bicontinuous morphology provides an interesting environment for loading and release properties. The domain sizes of the aqueous and oil channels (as shown in the insert of FIG. 6A) can be fine-tuned by varying the microemulsion components to allow full potential for solubilization and controlled release of the active ingredients. Moreover, by customizing the specific properties of the hydrophilic and hydrophobic portions, it is possible to control their interaction with the active ingredients, offering a greater potential for tailored release properties over a broad range of applications and conditions.

The carotenoid-microemulsion had shown good stability physically and chemically, with minimal degradation of carotenoids during storage. A slightly greater loss of carotenoids occurred at 65° C. compared to 25° C. There are several possible explanations for the degradation of the carotenoids. Among them, the influence of surface area is relevant to the present study. As compared to bulk crystalline carotenoids, the surface area of carotenoids in the nanometer range is significantly larger. This may reduce the stability by providing more contact surface between the carotenoids and the aqueous environment. In one study¹³, it was reported that the degradation of β-carotene in multiple nanosize emulsions was rapid, leaving only 32.3% of β-carotene after 4 weeks of storage at 50° C. The significant slow degradation of carotenoids in our bicontinuous microemulsions offers an advantageous and would make it possible to develop a commercial product with an appropriate length of shelf life.

With regard to the low conductivity for the systems containing less than 20 wt % aqueous content, it was likely due to the formation of W/O microemulsion droplets dispersed in the oil medium. The sharp increase in conductivity for the systems containing higher than 20 wt % aqueous content denoted the presence of numerous interconnected conducting channels, which are characteristics of bicontinuous microemulsion.

In conclusion, we have shown that our novel system can provide enhanced solubilization of carotenoids in the microemulsions, as well as in protecting the carotenoids from fast environmental reactivity (oxidation). This novel microemulsion technology also offers greatly enhanced flexibility for product development efforts, the capability to tailor different active ingredients loading of bicontinuous phases, and the controlled tolerance of bicontinuous phases for other ingredients.

### Example 2

The objective of this example was to prepare a solid nanodispersed self-emulsifying delivery system containing bicontinuous food-grade microemulsions of polyethoxylated sorbitan ester (Tween 80), water, limonene, ethanol and glycerol with excellent solubilization capacity, as liquid phase for the delivery of bioactive carotenoids, and to evaluate the enhanced bioavailability of the carotenoids from the solid form. The bioavailability study performed in the layer trial resulted in a 2.9-fold (191%) increase in the capsanthin absorption in the bird serum and 20% increase in the capsanthin deposition in the bird eggs from the nanodispersed formulation. Furthermore, the YCF score of the eggs from the birds treated with the nanodispersed formulation compared with a current formulation showed an average score of 11.25 and 8.75, respectively. These results clearly demonstrated the excellent ability of the new solid formulation in promoting solubilization and absorption of trans-capsanthin in vivo, through the use of endogenous microemulsion and size reduction effect.

### Materials and Methods

Materials.

Tween 80 (polyoxyethylene (20) sorbitan monooleate), limonene, ethanol, glycerol, wheat pollard and silica were of food-grade. All chemicals and reagents used in the analytical protocols were of analytical reagent grade. The water was double-distilled. A stabilized source of saponified red carotenoids from paprika extracts and Kem GLO 10 were also obtained from Kemin Animal Nutrition and Health (Asia-Pac) production. The determination of trans-capsanthin in blood serum and egg yolk were done using a standard method.

Preparation of Nanodispersed Kem GLO 10 Liquid Precursor.

The composition of bicontinuous carotenoid microemulsion was established in Example 1 which consists of tween 80:ethanol/limonene:glycerol/H2O. The weight ratio of limonene to ethanol and glycerol to water were fixed at 1:2 and 1:3, respectively. The ratio of oil/surfactant/water used were 32.5/32.5/35 (wt %) respectively, with 5.4 g/kg of trans-capsanthin. The bicontinuous carotenoid microemulsion formulation was prepared by method of Example 1. Briefly, carotenoid (37.2 wt %) was dissolved into the microemulsion mixture (15 wt %) of oil, surfactant, and co-surfactant at 25° C. in an isothermal water bath to facilitate solubilization. The resultant mixture was vortexed until a clear solution was obtained. It was then equilibrated at ambient temperature for at least 2 h and examined for signs of turbidity or phase separation prior to droplet size and optical studies.

Preparation of Nanodispersed Kem GLO 10 Dry.

A solid form of carotenoids was prepared. Briefly, silica and wheat pollard (21.8 wt %/26.0 wt %) were first added into a mixer. 52.2 wt % of nanodispersed carotenoid microemulsion containing saponified carotenoid (37.2 wt %) was then added into the mixer with constant stifling at room temperature for 15 min until homogenous mixture was obtained. The resultant powder was collected from the mixer and measured for the final trans-capsanthin content.

Characterization of Nanodispersed Kem GLO 10 Liquid Precursor.

The particle size distribution of sample was measured using an HORIBA particle size analyzer (LA-950V2). The particle size of the coarse saponified red carotenoids was also determined for comparison. Long-term stability testing involving particle size measurements was also conducted at given time intervals over one month storage at 25° C. To observe the morphology, liquid carotenoid-microemulsion was directly deposited onto carbon film supported by copper grids, stained with 1% aqueous solution of osmium tetroxide (OsO₄) and investigated using the transmission electron microscope (TEM) JEOL 1010 at 100 kV. The morphology of the coarse saponified red carotenoid was also determined for comparison.

Bioavailability.

A layer trial was carried out at Genetic Improvement & Farm Technologies Sdn. Bhd., Malaysia. The trial was conducted using a control and two different treatments (nanodispersed Kem GLO 10 and current Kem GLO 10). The control diet composition listed in Table 2 was used in this trial. The two formulations were included at rate of 1 kg/ton of feed. For the two experimental treatments the concentration of trans-capsanthin in the feed was approximately 5.4 g/ton. Twenty nine weeks old Lohamann Brown hens were used. The birds were fed with the experimental diets and allowed one week for adaptation to their new environment. The birds were placed in individual wire-floored cages arranged in two tires within an open-sided house under 14 L; 10 D lighting regime. Four cages of birds were fed from a single feed trough and considered as one experimental replicate. Each experimental diet was given to eight replicates (32 birds per treatment). Feed and water were provided ad libitum throughout the experimental diet. Each week, ten eggs and blood samples from each dietary group were taken for trans-capsanthin analysis. The plasma was separated from blood and the trans-capsanthin content was quantified. A team of 8 trained observers was asked to evaluate the eggs subjectively utilizing a commercial (DSM) color fan. Data were statistically analyzed by one-way ANOVA method.

### Results

Characterization of Nanodispersed Kem GLO 10 Liquid Precursor.

The composition of lipid excipients that constitutes the ternary phase of optimized nanodispersed Kem GLO 10 microemulsion is shown in Table 1. The spray dried particles of solid form had good flowability properties due to the presence of silica and wheat bran, which are regarded as suitable carriers for the solid dosage forms. The final trans-capsanthin content of the prepared solid form was 5.4 g/kg of trans-capsanthin.

TABLE 1
Composition of optimized nanodispersed Kem GLO 10
liquid precursor and dry solid

Composition (%)

| Vehicle Type | Name | Liquid | Solid |
|---|---|---|---|
| Oil | Limonene | 1.625 | 1.625 |
| Surfactant | Tween 80 | 4.875 | 4.875 |
| Co-surfactant | Ethanol | 3.25 | 3.25 |
| Aqueous phase | Glycerol/water | 5.25 | 5.25 |
| | (1:3) | | |
| Carotenoid | Saponified Paprika | 37.2 | 37.2 |
| | Oleoresin | | |
| Carrier | Silica/Wheat | NA | 47.8 |
| | pollard | | |

TABLE 2
Composition of poultry layer mash feed

| | |
|---|---|
| Specifications | 4130 |
| Moisture (% max) | 13 |
| Ash (% max) | 15 |
| Crude Protein (% min) | 17 |
| Crude Fat (% min) | 3 |
| Crude Fiber (% max) | 6 |
| Calcium (%) | 3.5-4.5 |
| Total Phosphorus (% min) | 0.5 |
| Measured Xanthophyll in Feed | 2.52 × 10⁻³ g/kg |

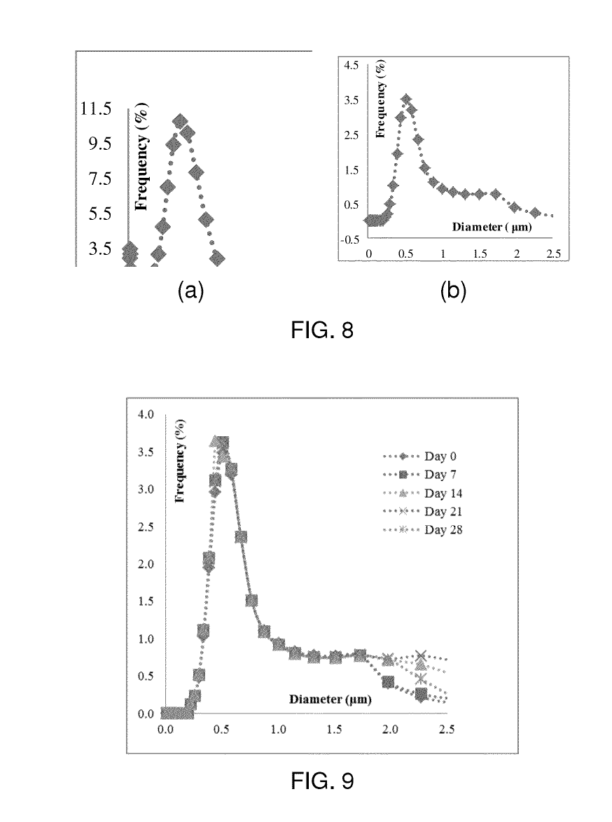

FIG. 8 shows the corresponding result of particle size analysis for the nanodispersed Kem GLO 10 liquid precursor and the coarse carotenoid (Kem GLO 10 liquid precursor). The particle size of the carotenoid in microemulsion is maintained at ca. 0.5 μm on average with contrast to a particle size of ˜20 μm for the coarse carotenoid.

FIG. 9 shows the particle size distribution of the nanodispersed Kem GLO 10 liquid precursor at the 0th, 7th, 14th, 21st and 28th day at room temperature (25° C.). There were no significant differences in particle size distribution for the sample during 1 month study. The long-term stability results demonstrated that the microemulsion-protected carotenoid was more stable and uniformly dispersed with no aggregation (as shown in FIG. 8(b)). It was hypothesized that the surfactant and oil phases used in this study not only influenced the formation of protective colloids responsible for establishing colloidal stability against agglomeration, but also helped the microemulsion formed in the stomach to be readily restructured into bicontinuous network. This may have occurred even in the absence of biliary phospholipid, thereby facilitating the uptake of carotenoids during the gastrointestinal passage.

Bioavailability.

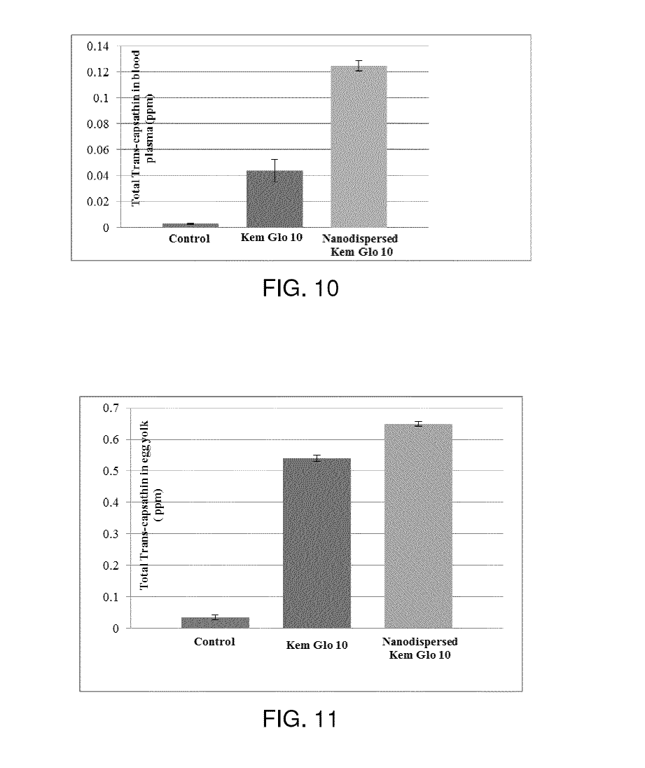

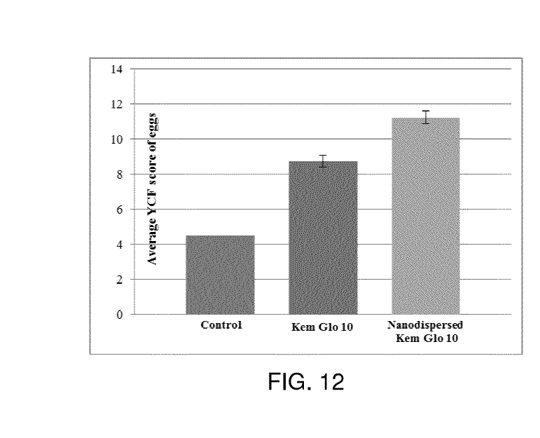

The bioavailability was studied by analyzing the trans-capsanthin in blood plasma and egg yolk of layer birds, after oral administration of nanodispersed Nano Kem GLO 10 comparing with current Kem GLO 10 and control treatment. The concentration-time profiles of trans-capsanthin in blood plasma and egg yolk from the two formulations are shown in FIGS. 10 and 11. As indicated in FIG. 10, particle sizes exerted a significant influence on the relative bioavailability. The blood plasma collected from the birds treated with nanodispersed Nano Kem GLO 10 showed an average value of 0.125 ppm of capsanthin, while the samples taken from the birds treated with the control diet and current Kem GLO 10 showed average values of 0.0028 ppm and 0.043 ppm, respectively. From these results it can be seen that there is a 2.9-fold (191%) increase in the capsanthin absorption from the nanodispersed Kem GLO 10 over the Kem GLO 10. From FIG. 11, the eggs collected from the control treatment and the current Kem GLO 10 showed 0.034 ppm and 0.54 ppm of capsanthin in the egg yolk, respectively. From these results it can be seen that there was a 20% increase in the capsanthin deposition from the nanodispersed Kem GLO 10 over the current Kem GLO 10. It is also important to note that there was a ˜19-fold increase in the capsanthin deposition in the egg from the nanodispersed Kem GLO 10 over the eggs collected from the birds treated with the control diet. As for the YCF score of the eggs, as shown in FIG. 12, eggs from birds treated with the nanodispersed Kem GLO 10 showed an average score of 11.25, while samples taken from birds treated with the current Kem GLO 10 showed an average score of 8.75. There was a 28.5% improvement in the color score of the nanodispersed Kem GLO 10 over the current Kem GLO 10. It is also important to note that there was a ˜1.5 fold increase in the yolk color in the egg arising from the nanodispersed Kem GLO 10, compared to the eggs collected from birds treated with the control diet.

### Discussion

From the trans-capsanthin concentration-time profiles in blood serum and egg yolk obtained for the nanodispersed Kem GLO 10 (FIGS. 10 and 11), a difference is seen compared to the results obtained for treatments using current Kem GLO 10 and control diet. This demonstrates the involvement of endogenous microemulsion and size reduction effect in promoting solubilization and absorption of trans-capsanthin in vivo. It has been reported that trans-capsanthin, like lutein, is a poorly water-soluble lipophilic compound, and follows the same route of lipid absorption^{14,15}. Although the exact mechanism of the absorption is not yet fully understood, trans-capsanthin has been thought to be absorbed through enterocytes by simple diffusion or receptor-mediated transport. Furthermore, trans-capsanthin is emulsified into small lipid droplets in the stomach and further incorporated into mixed micelles by the action of bile salts and biliary phospholipids, after which mixed micelles are taken up by enterocytes. Thus, the appearance of relatively low concentrations of trans-capsanthin in bird plasma and egg yolk was possibly due to the involvement of the aforementioned absorption mechanism. Furthermore, the use of surfactants is known to help the permeability of active ingredients through perturbation of the cell membrane (transcellular permeation) and/or modifying tight junction between the cells paracellular permeation¹⁶⁻¹⁸.

In the nanodispersed Kem GLO 10, Tween 80 was used as an emulsifier and we hypothesized that the presented the trans-capsanthin in solubilized microemulsion form in the gastrointestinal tract, possibly enhancing uptake of the trans-capsanthin by intestinal cells. After oral administration, no further dissolution is required as such a trans-capsanthin would be maintained in a fully solubilized state, after the bicontinuous microemulsion pre-concentrate self-emulsifies on contact with gastric fluid in the stomach. The already small and uniform bicontinuous arrays containing the trans-capsanthin may be further emulsified by the bile/lecithin micelles in the intestinal fluids, digested by enzymes and converted into even smaller lipid particles. This process of digestion would greatly increase the surface area of trans-capsanthin for transfer to the intestinal epithelium. This may explain the significant improvement of the YCF score for the eggs from the nanodispersed Kem GLO 10 treatment, indicating once again that the detected difference in bioavailability is highly significant.

### Conclusion

In conclusion, nanodispersed Kem GLO 10 dry containing bicontinuous microemulsion was successfully prepared for the delivery of trans-capsanthin. The droplet size analyses revealed characteristic size of liquid precursor of ˜0.5 μm compared to the coarse carotenoid of ˜20 μm. The bioavailability study performed in the layer trial resulted in a 2.9-fold (191%) increase in the trans-capsanthin absorption in the bird blood plasma and 20% increase in the trans-capsanthin deposition in the bird eggs from the nanodispersed formulation. Furthermore, the YCF score of the eggs from the birds treated with the nanodispersed formulation compared with current formulation showed an average score of 11.25 and 8.75, respectively. These results clearly demonstrated the excellent ability of the new solid formulation, with the involvement of endogenous microemulsion and size reduction effect, in promoting solubilization and absorption of trans-capsanthin in vivo.

### Example 3

### Materials and Methods

Materials.

Tween 80, limonene, ethanol, glycerol, wheat bran and silica were of food-grade. All chemicals and reagents used in the analytical protocols were of analytical reagent grade and double-distilled water was used. A stabilized source of saponified red carotenoids from paprika extracts and Kem GLO 10 were obtained as from Kemin Animal Health And Nutrition (Asia-Pac) production.

Preparation of Nanodispersed Kem GLO 10 Dry.

A solid form of the carotenoids was prepared. Briefly, silica and wheat pollard (21.8 wt %/26.0 wt %) were first added into a mixer. A nanodispersed carotenoid microemulsion, 52.2 wt % (as per Example 2) containing saponified carotenoid (37.2 wt %) was then added into the mixer with constant stirring at room temperature for 15 min until a homogenous mixture was obtained. The produced sample analyzed contained 12.47 g/kg of carotenoids.

Preparation of Treated Feed Meal.

The poultry layer mash feed (as per Example 2) contained 17% protein, 3% fat and not more than 6.0% crude fiber. Treated feed was prepared by a layer test facility (Genetic Improvement & Farm Technologies Sdn. Bhd., Malaysia) by adding either 0.5 kg/ton or 1.0 kg/ton nanodispersed Kem GLO 10 and Kem GLO 10 to the low carotenoids feed.

Storage of Feed Meal.

Treated feed meal was delivered to Kemin Animal Health And Nutrition (Asia-Pac) by the layer test facility and stored in open-bag at 25° C. for 3 months. The pigment content was determined according to AOAC method 970.64. Multiple analyses were performed on each sample and the resulting values were averaged.

### Results

Total carotenoids losses during 3 months storage of Kem GLO 10 averaged 44.75%, compared with lower losses of 22.25% observed in the feed meal treated with nanodispersed Kem GL 10. As shown in Table 3, Kem GLO 10 lost one half of the initial carotenoids during 3-month storage period while the carotenoids stability in nanodispersed Kem GLO 10 (made with the microemulsion technology) was much improved, losing only one third of the initial carotenoids at similar dosage. Also, the relative stability of the carotenoids also decreased progressively when a greater amount of carotenoids was added to the feed (at 1.0 kg/ton). There was a further 10% and 20% drop in the carotenoids retention for Kem GLO 10 and nanodispersed Kem GLO 10, respectively compared to the lower 0.5 k g/ton addition. We also observed that the degree of carotenoids lost from feed treated with nanodispersed Kem GLO 10 is more gradual as compared to that of Kem GLO 10 suggesting it may be due to the different method of preparation and better protection efficacy (Table 4).

TABLE 3
Stability of the carotenoids from Kem GLO 10 and
nanodispersed Kem GLO 10 added to layer feed

| | Kem GLO 10 | | Nanodispersed Kem GLO 10 | |
|---|---|---|---|---|
| | Initial | Retention | Initial | Retention |
| | carotenoids | after 3 | carotenoids | after |
| | concentration | months at | concentration | 3 months at |
| Dosage | (g/ton) | 25° C. (%) | (g/ton) | 25° C. (%) |
| 0.5 kg/ton | 7.02 | 55.25 | 6.24 | 77.75 |
| 1.0 kg/ton | 14.04 | 43.52 | 12.47 | 60.10 |

TABLE 4
Xanthophyll Stability Test in Feed

| Dosage of | | |
|---|---|---|
| Nanodispersed ORO | Total Xanthophyll | Total Xanthophyll |
| GLO 20 in Feed | Recovery (g/ton) | Recovery (g/ton) |
| (kg/ton) | (Week 0) | (Week 2) |
| 0.25 | 4.95 | 4.49 |
| 0.5 | 9.70 | 9.55 |
| 0.75 | 14.45 | 14.0 |
| 1.0 | 20.48 | 15.7 |
| Dosage | Total Xanthophyll | Total Xanthophyll |
| of ORO GLO | Recovery | Recovery |
| 20 in Feed (kg/ton) | (Week 0) | (Week 2) |
| 0.25 | 7.50 | 5.04 |
| 0.5 | 10.12 | 10.86 |
| 0.75 | 13.19 | 8.93 |
| 1.0 | 19.31 | 11.91 |

### Discussion

As mentioned earlier, several factors may influence the relative stability of carotenoids when added to a feed. It is known that when carotenoids are in the encapsulated form, they can be well protected from premature degradation that may be induced by light, oxygen and/or heat. The nanodispersed Kem GLO 10 had improved carotenoid retention as compared to the Kem GLO 10, perhaps because the carotenoid when solubilized and contained within the microemulsion system is better protected due to the molecular architecture of the pigment within the microemulsion matrix. The microemulsion is hypothesized to provide a physical barrier between the pigment and the oxidation catalysts (such as oxygen) and also its light-scattering property can help to reduce the intensity of light reaching the pigment entrapped within them. In addition, we also foresee that the smaller particle size of the carotenoid pigment achieved using microemulsion will enable it to be easily and homogeneously distributed into the interior porous passage of the carrier granules that will further help to reduce the loss caused by oxidation on the surface and enhance the stability of the product.

### Example 4

Nanodispersions of various hydrophilic and lipophilic substances were made using the ingredients set out in Tables 5-9.

TABLE 5
Antimicrobial agent: Monolaurin (lipophilic)

| Ingredients (wt %) | Ex.-1 | Ex.-2 |
|---|---|---|
| Tween 80 | 35.0 | 25.0 |
| Limonene/Ethanol (1:2) | 35.0 | 25.0 |
| Glycerol/Water (1:3) | 30.0 | 50.0 |
| Monolaurin (ppm) | 500-1000 | 500-1000 |

| Ingredients (wt %) | Ex.-3 |
|---|---|
| Ethoxylated castor oil (EL35) | 32.5 |
| Propionic acid | 32.5 |
| Water | 35.0 |
| Monolaurin (ppm) | 500-1000 |

TABLE 6
Vitamin C and antioxidant: Ascorbic acid (hydrophilic)

| Ingredients (wt %) | Ex.-4 | Ex.-5 |
|---|---|---|
| Tween 80 | 45.0 | 35.0 |
| Limonene/Ethanol (1:2) | 45.0 | 35.0 |
| Glycerol/Water (1:3) | 10.0 | 30.0 |
| Ascorbic acid (ppm) | 200-500 | 500-1000 |

TABLE 7
Amino acids: L-lysine, L-arginine hydrochloride (hydrophilic)

| Ingredients (wt %) | |
|---|---|
| | Ex.-6 |
| Tween 80 | 32.5 |
| Limonene/Ethanol (1:2) | 32.5 |
| Glycerol/Water (1:3) | 35.0 |
| L-Lysine Hydrochloride (wt %) | 1-5 |
| | Ex.-7 |
| Tween 80 | 32.5 |
| Limonene/Ethanol (1:2) | 32.5 |
| Glycerol/Water (1:3) | 35.0 |
| L-Arginine Hydrochloride (wt %) | 1-5 |

TABLE 8
Bile salt (amphiphilic)

| Ingredients (wt %) | Ex.-8 |
|---|---|
| Tween 80 | 32.5 |
| Limonene/Ethanol (1:2) | 32.5 |
| Glycerol/Water (1:3) | 35.0 |
| Bile salt (wt %) | 0.1-1 |

TABLE 9
Enzyme: Amylase (lipophilic)

| Ingredients (wt %) | Ex.-9 |
|---|---|
| Tween 80 | 32.5 |
| Limonene/Ethanol (1:2) | 32.5 |
| Glycerol/Water (1:3) | 35.0 |
| Amylase liquid (wt %) | 0.1-1.0 |

A particular application where both lipophilic and hydrophilic substances may be combined in a single microemulsion of the present invention is in the preparation of dyes for biological tissues such as is described in U.S. patent application Ser. No. 13/433,526, filed Mar. 29, 2012, and incorporated herein in its entirety by this reference. The subject application describes dyes that contain lutein or zeaxanthin, both of which are lipophilic, with traditional dyes, such as trypan blue, which often are hydrophilic.

### Example 5

The microemulsions of the present invention can be used to form powders that have enhanced flowability. This is shown by the effect on the angle of repose of a pile of the material as set out in Table 10.

TABLE 10
Angle of Repose Comparison

| | Nano Kem | Kem GLO | Nano Oro | Oro GLO |
|---|---|---|---|---|
| | 10 GLO Dry | 10 Dry | GLO 20 Dry | 20 Dry |
| Angle of repose | 19.3 | Not flowable | 19.69 | 25.27 |

The angle of repose is typically below 40 for a flowable product and the smaller the angle of repose the more flowable the product. The data show that the microemulsions of the present invention form powders that have enhanced flowability.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

### REFERENCES

1. Solans, C., Pons, R., Kunieda, H “Overview of basic aspects of microemulsions” Industrial Applications of Microemulsions, Solans, C., Kunieda, H. Eds.; Dekker: New York, (1997); 66:1-17.
2. Dungan, S. R. “Microemulsions in foods: properties and applications” ibid 148 170
3. Holmberg, K. “Quarter century progress and new horizons in microemulsions” in Micelles, Microemulsions and Monolayers, Shah, O. Ed.; Dekker: New York (1998) 161 192.
4. Garti, N., “Microemulsions, emulsions, double emulsions and emulsions in food” in Formulation Science (proceeding from formulation forum '97-association of formulation chemists) (1998) 1, 147 219.
5. Ezrahi, S., Aserin, A., Garti, N. in Microemulsions-fundamental wad applied aspects Kumar, P. and Mittal, K. L. Eds. Marcel Dekker, Inc. New York (1999) “Aggregation behavior in one-phase (Winsor IV) systems” 185 246.
6. Garti, N., Clement, V., Leser, M., Aserin, A. Fanun, M. “Sucrose esters microemulsions J. Molec. Liquids (1999) 80, 253 296.
7. Anton, N., Benoit, J. P., & Saulnier, P. (2008). “Design and production of nanoparticles formulated from nano-emulsion templates a review”. Journal of Controlled Release, 128(3), 185-199.
8. A. Spernath, A. Yaghmur, A. Aserin, R. E. Hoffman and N. Garti. (2002). “Food-Grade Microemulsions Based on Nonionic Emulsifiers: Media To Enhance Lycopene Solubilization”. J. Agric. Food Chem., 50, 6917-6922.
9. A. Spernath, A. Yaghmur, A. Aserin, R. E. Hoffman and N. Garti, (2003). “Self-Diffusion Nuclear Magnetic Resonance, Microstructure Transitions, and Solubilization Capacity of Phytosterols and Cholesterol in Winsor IV Food-Grade Microemulsions”, J. Agric. Food Chem., 51, 2359-2364.
10. A. Yaghmur, A. Aserin, I. Tiunova and N. Garti. (2002). “Sub-zero temperature behaviour of non-ionic microemulsions in the presence of propylene glycol by DSC”. J. Therm. Anal. Cal., 69, 163-177.
11. A. Yaghmur, A. Aserin, B. Antalek and N. Garti, (2003), “Microstructure Considerations of New Five-Component Winsor IV Food-Grade Microemulsions Studied by Pulsed Gradient Spin-Echo NMR, Conductivity, and Viscosity”, Langmuir, 19, 1063-1068.
12. Chow P. Y. and Gan L. M. (2005). “Microemulsion Polymerizations and Reactions” Adv Polym Sci., 175: 257-298.
13. Yoshida, K., Sekine, T., Matsuzaki, F., Yanaki, T., & Yamaguchi, M. (1999). “Stability of vitamin A in oil-in-water-in-oil-type multiple emulsions”. Journal of the American Oil Chemists Society, 76, 195-200.
14. Yonekura, L., Nagao, A., “Intestinal absorption of dietary carotenoids”, Mol. Nutr. Food Res. 51 (2007) 107-115.
15. Clevidence, B. A., Bieri, J. G., “Association of carotenoids with human plasma lipoproteins”, Methods Enzymol. 214 (1993) 33-46.
16. Franceschinis, E., Voinovich, D., Grassi, M., Perissutti, B., Filipovic-Grcic, J., Martinac, A., Meriani-Merlo, F., “Self-emulsifying pellets prepared by wet granulation in high-shear mixer: influence of formulation variables and preliminary study on the in vitro absorption”, Int. J. Pharm. 291 (2005) 87-97.
17. Tuleu, C., Newton, J. M., Rose, J., Euler, D., Saklatvala, R., Clarke, A., Booth, S., “Comparative bioavailability study in dogs of a self-emulsifying formulation of progesterone presented in a pellet and liquid form compared with an aqueous suspension of progesterone”, J. Pharm. Sci. 93 (2004) 1495-1502.
18. Kohli, K., Chopra, S., Dhar, D., Arora, S., Khar, R. K., “Self-emulsifying drug delivery systems: an approach to enhance oral bioavailability”, Drug Discov. Today 15 (2010) 958-965. SA-12-00765.
19. Livingston, A. L., Bickoff, E. M. and Thomson, C. R., “Effect of added animal fats and antioxidant on stability of xanthophyll concentrates in mixed feeds”, Journal of Agricultural and Food Chemistry 3 (1955) 439.

We claim:

1. A method of encapsulating a composition, comprising the steps of:
(a) forming a bicontinuous or Winsor type III microemulsion by combining an emulsifier, a solvent, and a co-emulsifier and stirring or agitating the combination;
(b) adding the composition to the microemulsion and mixing to substantial homogeneity; and
(c) optionally blending the microemulsion of step (b) with a carrier.

2. A method of encapsulating a composition, comprising the steps of:
(a) mixing the composition with a co-emulsifier by combining;
(b) adding an emulsifier, a solvent, and a co-emulsifier to form a bicontinuous or Winsor type III microemulsion; and
(c) optionally blending the microemulsion of step (b) with a carrier.

3. A method of claim 1, wherein the emulsifier is polysorbate 80, the solvent is selected from the group consisting of glycerol and limonene, and the co-emulsifier is ethanol.

4. A method of claim 1, further comprising water added in either step (a) or step (b) or both.

5. A method of claim 1, wherein the composition is either oil-soluble or water-soluble.

6. A method of claim 1, wherein the composition is selected from the group consisting of organic acids, surfactants, flavors, colors, antimicrobials, micronutrients, medications, eye dye and nutraceuticals.

7. A bicontinuous microemulsion to enhance encapsulation and stability of amphiphilic or lipophilic oil-soluble or hydrophilic water-soluble materials into feed and food compositions, comprising:
(a) an oil phase comprising said amphiphilic or lipophilic oil-soluble material;
(b) an aqueous phase comprising said amphiphilic or hydrophilic water-soluble material; and
(c) a food grade emulsifier system comprising
(i) an ionic or non-ionic or zwitterionic emulsifier, and
(ii) a co-emulsifier; and
(d) wherein said oil phase is dispersed as particles having an average diameter of below 1 μm, within said aqueous phase; or
(e) wherein said aqueous phase is dispersed as particles or continuous phase having an average diameter of below 1 μm, within said oil phase.

8. The bicontinuous microemulsion according to claim 7, wherein the aqueous phase comprises from about 10% to about 90% of the total, the balance being oil phase and food grade emulsifier system, or wherein the oil phase comprises from about 10% to about 90% of the total, the balance being aqueous phase and food grade emulsifier system.

9. The bicontinuous microemulsion according to claim 7, wherein the aqueous or oil phase contains dissolved materials selected from colorants, vitamins, juices, antioxidants, extracts of natural components, medicaments, simple phenols, polyphenols, bioflavonoids, dairy products, proteins (including enzymes), peptides, amino acids, salts, sugars, sweeteners, flavors, flavor precursors, nutrients, minerals, acids and seasonings, and mixtures thereof.

10. The bicontinuous microemulsion according to claim 7, wherein the emulsifier is selected from the group consisting of glycerol ester of fatty acids, monoglycerides, diglycerides, ethoxylated monoglycerides, polyglycerol ester of fatty acids, lecithin, glycerol ester of fatty acids, sorbitan esters of fatty acids, sucrose esters of fatty acids, and mixtures thereof.

11. The bicontinuous microemulsion according to claim 7, wherein the co-emulsifier is a water miscible alcohol emulsifying agent selected from the group consisting of ethanol, propanol, propylene glycol, glycerol and mixtures thereof.

12. The bicontinuous microemulsion according to claim 7, wherein the oil is selected from the group consisting of limonene, vegetable oils, animal oils, polyol polyesters and mixtures thereof.
